(19) United States
(12) Patent Application Publication
(10) Pub. No.: US 2025/0224562 A1
(43) Pub. Date: Jul. 10, 2025

(54) UNIVERSAL CONNECTOR/ADAPTOR FOR FIBER OPTIC CABLES

(71) Applicant: VIAVI SOLUTIONS INC., Chandler, AZ (US)

(72) Inventors: Robert Matthew ADAMS, Ottawa (CA); Darko CUGALJ, Ottawa (CA); Jeffery Stephen GRAVES, Oxford Station (CA); Malcolm SMITH, Ottawa (CA)

(73) Assignee: VIAVI SOLUTIONS INC., Chandler, AZ (US)

(21) Appl. No.: 18/407,844

(22) Filed: Jan. 9, 2024

(51) Int. Cl. G02B 6/255; G01M 11/08

(52) U.S. Cl. CPC G02B 6/2556; G01M 11/088

(57) ABSTRACT

Systems, methods, and devices for a universal connector/adaptor to connect any of a multitude of different fiber optic cables (including any bare ferrule surface and/or end connector thereof) with any of a multitude of devices for cleaning, polishing, finishing, inspecting, examining, or testing a fiber optic cable (including its bare ferrule surface and/or end connector). In one aspect, a universal connector/adaptor includes a universal outer portion and a detachable/interchangeable inner portion, where the universal outer portion and portions of the detachable/interchangeable inner portion can connect with any of the multitude of devices, and the detachable/interchangeable inner portion may hold a specific end connector, bare end surface, and/or fiber optic cable. In another aspect, a universal connector/adaptor kit may include a universal outer portion and a multitude of detachable/interchangeable inner portions, where each detachable/interchangeable inner portion is suited for a specific end connector, bare end surface, and/or fiber optic cable.

### TECHNICAL FIELD

This disclosure is directed generally to the fiber optic cables, and more specifically, to a universal connector/adaptor to connect the end of any type of fiber optic cable with any type of device for cleaning, polishing, viewing, testing, examining, and/or inspecting fiber optic cables (collectively referred to herein as “test devices”).

### BACKGROUND

Fiber optic cable may be used for a wide variety of purposes, including, for example, communication transmission over, e.g., telecommunication networks, Ethernet networks, etc. The fiber optic cable may need to meet certain standards for optimal usage, including, for example, levels of transmissibility as a light medium, levels of cleanliness of end connectors (particularly ferrule surfaces), and/or a lack of defects in manufacturing, structure, and/or materials. Any user of any type of fiber optic cable may need to inspect and/or examine fiber optic cable for a multitude of purposes, including, for example, quality control (e.g., for the detection of imperfections, dirt, etc., in a manufacturing setting), testing/inspection before/during use in the field (e.g., determining if dirty, usable, defective, and/or up to required standards and/or specifications for its particular usage, its particular type of network, etc.), inspection before/during the testing of equipment under laboratory conditions, etc., as would be understood by one of ordinary skill in the art. Furthermore, any user of any type of fiber optic cable may need to polish, clean, and/or otherwise finish a bare end and/or end connector of a fiber optic cable for a multitude of purposes, including, for example, for the final finishing and/or further cleaning/polishing in a manufacturing setting (e.g., after detecting dirt, imperfections, etc.), cleaning/polishing before/during inspection and/or use in the field (e.g., ensuring accurate testing results), etc., as would be understood by one of ordinary skill in the art.

However, a multitude of different adaptors may be needed for a single fiber optic cable to be connected to the variety of different devices for testing, examining, inspecting, cleaning, polishing, etc. fiber optic cables. In addition, the number of types of fiber optic cables are also steadily increasing—each of which may need its own new adapter. Generally speaking, any systems, apparatuses, and/or methods which may reduce the complexity of working with fiber optic cables may be beneficial, in that they may save time, reduce costs, increase efficiency, and/or otherwise improve such work.

### BRIEF DESCRIPTION OF DRAWINGS

Features of the present disclosure are illustrated by way of example and not limited in the following figure(s), in which like numerals indicate like elements, in which:

FIGS. 1A-1F illustrate various adapters and accessories for fiber optic cables and/or end connectors of fiber optic cables to connect to test devices, which may be replaced by examples of the present disclosure.

FIGS. 2A-2D illustrate a universal connector/adapter (UCA) for various Devices Under Test (DUTs) to fit into various test devices, according to an example of the present disclosure.

FIGS. 3A-3D illustrate a universal connector/adapter (UCA) with an inner portion adapted for a bare ferrule of a fiber optic cable as a device under test (DUT), according to an example of the present disclosure.

FIGS. 4A-4D illustrate a universal connector/adapter (UCA) with an inner portion adapted for a chuck of a bare fiber optic cable as a device under test (DUT), according to an example of the present disclosure.

FIG. 5 illustrates a universal connector/adapter (UCA) with an inner portion adapted for a fiber array unit (FAU) as a device under test (DUT), according to an example of the present disclosure.

### DETAILED DESCRIPTION

For simplicity and illustrative purposes, the present disclosure is described by referring mainly to examples and embodiments thereof. In the following description, numerous specific details are set forth in order to provide a thorough understanding of the present disclosure. It will be readily apparent, however, that the present disclosure may be practiced without limitation to these specific details. In other instances, some methods and structures readily understood by one of ordinary skill in the art have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

As discussed above, any type of the rapidly proliferating varieties of fiber optic cables may need to be connected to a variety of devices for a multitude of purposes, and in a wide variety of environments (including, e.g., in a factory where fiber optic cables are manufactured; in a laboratory where a network or system using fiber optic cables is being field tested; in the field where a technician may be testing/inspecting/examining components/systems which are or will be actively using fiber optic cable, etc.). However, the interoperability of fiber optic cable equipment and fiber optic cable is becoming increasingly problematic, as often different, separate adapters are needed for the same fiber optic cable to interoperate with the same and/or different equipment in any of these environments/situations. Not only do the sizes and types of fiber optic cables vary (and are also increasing in number as well as evolving and changing over time), but also the end connectors for fiber optic cables vary greatly (and are also increasing in number as well as evolving and changing over time), making interoperability with test equipment an increasing concern.

As an example, a user splicing two optic fiber cables together in a fusion splicing machine may initially need to put each of the ends to be spliced together in an individualized chuck for holding in the fusion splicing machine during splicing. If the user needs to examine the end of one or both of the fiber optic cables, the user may have to take the fiber optic cable out of its chuck and put it in the appropriate adapter for the examination device. If dirt is found, or the need for cleaning/polishing is indicated, by the examination device, that adapter must be removed from the fiber optic cable and a different adapter placed on the fiber optic cable so that it may be connected to the cleaning/polishing equipment. Similarly, if the user needs to check the other end of the fiber optic cable (e.g., to determine if the component at the other end is properly connected and/or properly transmitting/receiving through the fiber optic cable), yet again the user must remove either the chuck or an adapter, and place another different adapter appropriate for connecting to a device for testing the communication capabilities of the fiber optic cable.

According to examples of the present disclosure, a universal connector/adaptor may be provided, having a universal outer portion or shell which may connect with any type of device, and a detachable/interchangeable inner portion which may suitable for holding the bare end of a specific fiber optic cable, a specific type of end connector of a fiber optic cable, and/or a specific chuck or fitting used by a specific device to connect to a fiber optic cable (such as, e.g., a fusion splicer). In some examples, a multitude of different detachable/interchangeable inner portions, each suited to a specific fiber optic cable, end connector, chuck/fitting, etc., may be swapped in and out of the universal outer portion so that the universal connector/adaptor may connect a device to any type of specific fiber optic cable, end connector, chuck/fitting, etc. In some examples, a universal connector/adaptor with a specific detachable/interchangeable inner portion may connect a specific type of fiber optic cable, end connector, chuck/fitting, etc., to any of a multitude of devices for, e.g., cleaning, polishing, inspecting, examining, and/or otherwise testing or finishing.

In some examples, a universal connector/adaptor may be provided, including an outer, hinged clamshell which can open and close, revealing a partially hollow inside to which a user may insert and detach any one of a multitude of detachable/interchangeable inner portions, each of which is especially designed to hold a specific type of fiber optic cable, end connector, chuck/fitting, etc. In some examples, each detachable/interchangeable portion is made up of a bottom portion to attach to the bottom of the outer clamshell, and a top portion to attach to the top of the outer clamshell, where the top and bottom portions may securely hold the fiber optic cable, end connector, chuck/fitting, etc., in place when the outer clamshell is securely closed.

According to examples of the present disclosure, systems and/or methods are provided, in which a universal connector/adaptor may have a universal outer portion and a multitude of different detachable/interchangeable inner portions, each of which may be suitable for holding a specific device under test (DUT) in place. In some examples, the universal connector/adaptor may connect any DUT with a large variety of different fiber optic cable equipment.

Some advantages and benefits of the devices, systems, and methods described herein would be readily apparent to one of ordinary skill in the art. For example, a universal connector/adaptor device, system, and/or method according to the present disclosure may simplify interoperability with a large variety of different types of fiber optic cable equipment, involved in a multitude of different processes, tasks, procedures, etc. As another example, a universal connector/adaptor device, system, and/or method according to the present disclosure may minimize tooling requirements and reduce the equipment (e.g., adaptors and adaptor accessories) which needs to be kept on hand. As yet another example, a universal connector/adaptor device, system, and/or method according to the present disclosure may enable a user to quickly connect and disconnect various devices under test (DUT), in a variety of processes, with a multitude of instrumentation interfaces. Other benefits and advantages are described in greater detail below; some benefits and advantages would be apparent to one of ordinary skill in the art in light of the present disclosure, even if not specifically discussed herein.

For purposes of simplicity and clarity of explanation, the term “test device” as used herein may refer to any device for cleaning, polishing, inspecting, examining, and/or any type of testing or finishing of any type of fiber optic cable (including any part of the fiber optic cable, such as, e.g., any bare ferrule surface of the fiber optic cable, any type of end connector of the fiber optic cable, any bare end of the fiber optic cable, etc., as would be understood by one of ordinary skill in the art). Accordingly, a test device may include, for example, any type of system for viewing and/or analyzing the bare ends and/or end connectors of fiber optic cables (such as, e.g. a microscopic system); any device for cleaning or polishing end connectors and/or ferrule ends of fiber optic cables (including, e.g., automated cleaning systems and/or systems for inspecting, analyzing, and cleaning (when found necessary)); any type of power measurement device or power meter; any type of transmissibility measurement device or meter (such as, e.g., an Insertion Loss/Return Loss meter, a Swept Wavelength meter, an Optical Time-Domain Reflectometer (OTDR), an Optical Spectrum Analyzer (OSA), etc.); any type of network transmission analyzer (which may test for, e.g. adherence to specific protocols and/or standards); etc., as would be understood by one of ordinary skill in the art.

As indicated by the variety of test devices, what may be tested for also varies widely and may be unique and tailored to the specific fiber optic cable, the particular end connector, the communication usage of the fiber optic cable, the particular environment in which the fiber optic cable may be used, etc., as would be understood by one of ordinary skill in the art. In some examples, the test or tests performed by the test device may be established by various industry associations, such as the Fiber Optic Association (FOA); the Building Industry Consulting Service International (BICSI); the Electronic Industries Alliance (EIA)/Telecommunication Industry Association (TIA); the International Electrotechnical Commission (IEC) (sometimes with the International Organization for Standardization (IOS/IEC)); the 3rd Generation Partnership Project (3GPP), which promulgates evolving telecommunications standards such as Long Term Evolution (LTE), 5G, 5GNR, and 6G; the European Telecommunications Institute (ETSI); the Open Radio Access Network (O-RAN) Alliance; the Institute of Electrical and Electronic Engineers (IEEE); the International Telecommunications Union (ITU); and the American National Standards Institute (ANSI). As specific, non-limiting examples, the IEC has promulgated IEC 61300-3-35, which specifies pass/fail requirements for fiber optic cable overall quality, ferrule end-faces, end connectors, life cycle objectives, etc.; the IEEE has promulgated IEEE 802.3z, 802.3ae, 802.3db, etc., as various optical Ethernet standards; the FOA has promulgated FOA-3 for measuring optical power, FOA-4 for OTDR testing, etc.; and ANSI and TIA have promulgated ANSI/TIA-455-95-B for Absolute Optical Power Test for Optical Fibers and Cables.

For purposes of simplicity and clarity of explanation, the terms “device under test,” “DUT,” “sample,” “sample/DUT,” and any variations thereof may be used interchangeably, and as used herein may refer to any optic fiber cable (including any part of the fiber optic cable, such as, e.g., any bare ferrule surface of the fiber optic cable, any type of end connector of the fiber optic cable, any bare end of the fiber optic cable, etc.), as well as any chuck/fitting used to present any optic fiber cable to any fiber optic cable equipment (such as, e.g., a fusion splicer), as would be understood by one of ordinary skill in the art). Accordingly, a “device under test,” “DUT,” “sample,” “sample/DUT,” and any variations thereof as used herein may include, but are not limited to, any fiber optic cable in the IOS/IEC 11801-1 series, the IEC 60793-2-10 series, the TIA-568.3-D series, the TIA/EIA 492AAAx series, and in accordance with any ITU-T standards (such as, e.g., G.651.1). Examples of the present disclosure are expressly directed to any past, present, and/or future fiber optic cables (including any part of the fiber optic cable, such as, e.g., any bare ferrule surface of the fiber optic cable, any type of end connector of the fiber optic cable, any bare end of the fiber optic cable, etc.), and thus “device under test,” “DUT,” “sample,” “sample/DUT,” and any variations thereof as used herein may include any past, present, and/or future fiber optic cables (including any part of the fiber optic cable, such as, e.g., any bare ferrule surface of the fiber optic cable, any type of end connector of the fiber optic cable, any bare end of the fiber optic cable, etc.).

For purposes of simplicity and clarity of explanation, the term “end connector” as used herein may refer to any type of connector used in fiber optics, including, but not limited to, any EIA/TIA end connector standard, as listed in the 604 series (e.g., “TIA-604-XX”) and/or identified by a Fiber Optic Connector Intermateability Standard (FOCIS) document, and/or any International Electrotechnical Commission (IEC) standard. For example, the term “end connector” as used herein may refer to a simplex end connector; any type of Polished Connector (PC), such as, e.g., an Angled PC (APC), an Ultra PC, etc.; a Straight Terminus (ST) end connector (FOCIS-2/TIA-604-2); a Subscriber Connector or Snap-in Connector (SC) (FOCIS-3/TIA-604-3, IEC 61754-4, etc.); a Fiber Connector/Ferrule Connector/Fiber Channel (FC) (FOCIS-4/TIA-604-4); a Lightwave Connector (LC) (FOCIS-10/TIA-604-10); an LX-5 end connector (FOCIS-13/TIA-604-13); a MU end connector (FOCIS-17/TIA-604-17); a Multi-fiber Push-On/Pull-Off or Multi-Position Optical (MPO) end connector (12 fiber FOCIS-5/TIA-604-5, 16 fiber FOCIS-18/TIA-604-18, IEC 61754-7, etc.); a Sub Miniature A (SMA) end connector (e.g., IEC 61754-2); an MT-RJ end connector (e.g., FOCIS-12/TIA-604-12, IEC 61754-18, etc.); a Mechanical Transfer (MT) jack/connector; an E-2000 connector (IEC 61754-15); an F-3000 connector (IEC 61754-20); any other standard interface/connector used for fiber optics (past, present, and future); and/or any other form of end connector suitable for use with fiber optics, as would be understood by one of ordinary skill in the art.

As mentioned above, in any field that uses any type of fiber optic cable, there may be a need to clean, polish, inspect, examine, and/or otherwise test or finish the fiber optic cable being used, including the end connectors (if any) of the fiber optic cable being used. To do so, the bare end of the optic fiber cable, the end connector of the fiber optic cable, and/or the chuck/fitting holding the bare end or the end connector of the optic fiber cable, may be attached to a device for such cleaning, polishing, inspecting, examining, and/or other testing or finishing, as would be understood by one of ordinary skill in the art. Adaptors and their accessories may be used to attach such DUT to such test devices. See, for example, U.S. Pat. No. 11,391,933 for an OPTICAL ADAPTER SYSTEM; U.S. Pat. No. 11,086,080 for an ALIGNMENT GUIDE FOR INSPECTING A FIBER OPTIC END FACE; and U.S. Pat. No. 11,828,926 for SHAPED REFLECTOR FOR COAXIL ILLUMINATION OF NON-NORMAL SURFACES, all of which are assigned to the present assignee and are hereby incorporated by reference in their entireties.

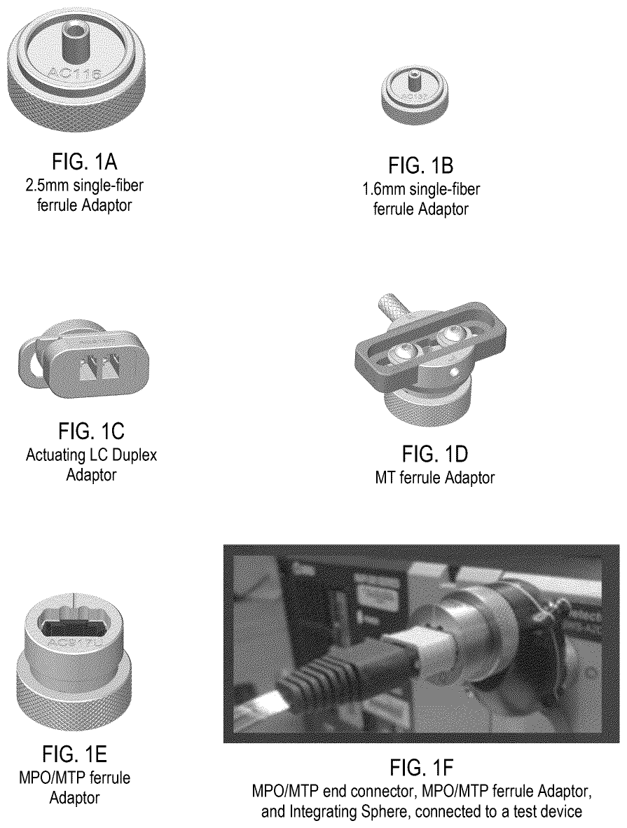

FIGS. 1A-1F illustrate various adapters and accessories for fiber optic cables and/or end connectors of fiber optic cables to connect to test devices, which may be replaced by examples of the present disclosure. The specific adaptors and accessories in FIGS. 1A-1F are shown merely for purposes of illustrating the wide variety of adaptors used to interconnect with different test devices, and are not limiting in any way to examples of the present disclosure.

FIGS. 1A and 1B illustrate adapters for a single-fiber ferrules: FIG. 1A shows a 2.5 mm single fiber ferrule adaptor, while FIG. 1B shows a 1.25 mm single fiber ferrule adaptor. FIG. 1C illustrates an adapter for a fiber optic cable with an LC end connector-more specifically, a locking adaptor for an actuating LC duplex end connector. FIG. 1D illustrates a locking MT ferrule adaptor for either a 12×6 or 16×4 array. FIG. 1E illustrates an example of a locking MPO-MTP adapter for either a 12×6 or 16×4 array, while FIG. 1F illustrates an example of an MPO end connector in an MPO-MTP adapter connected to an integrating sphere which is connected to a test device.

As indicated by the various adaptors and accessories shown in FIGS. 1A-1F, the many different types of fiber optic cables and/or end connectors of fiber optic cables may require a large number of adaptors and accessories (such as integrating spheres) which match each individual type of fiber optic cable and/or end connector. As various vendors in the various technologies which utilize fiber optic cables may develop even more custom terminations for fiber optic cables, the number of adaptors and accessories required to interconnect the different types of fiber optic cables and/or end connectors with different types of test devices may become increasingly unwieldy.

According to examples of the present disclosure, a universal connector/adapter may provide an adaptation middle-layer between a number of different test devices and any type of fiber optic cable and/or any type of fiber optic cable termination which may need cleaning, polishing, finishing, testing, examining, inspecting, etc. In some examples, the universal connector/adapter may be employed with any fiber optic cable interface, whether a termination end surface, an end connector, or other type of interface, including, for example, bare optic fiber, slider assemblies, splice chucks, fiber-ribbons, ferrules, fiber array unit (FAU) end connectors, MT end connectors, MPO end connectors, ST end connectors, SC end connectors, FC/PC end connector, FC/APC end connectors, etc., as would be understood by one of ordinary skill in the art in light of the present disclosure.

According to examples of the present disclosure, the universal connector/adaptor may include an outer portion adapted to fit different inner portions configured for different types of fiber optic cable termination, including specific customized termination styles. Accordingly, a user may be able to easily share test devices and switch between different types of test devices in order to perform different tests, inspections, and examinations on the same DUT without having to reconfigure equipment. Similarly, a user may be able to easily switch between different DUTs being tested while keeping the same universal connector/adapter and the same test devices, by switching out and replacing the inner portion(s) of the universal connector/adapter. In some examples, the outer portion may be a hinged clamshell which is opened to insert and detach the inner portion(s) for the particular DUTs, and then closed and shut with both the inner portion(s) and the DUT locked in place inside.

Generally speaking, two common usages of a universal connector/adaptor according to examples of the present disclosure may be (1) to hold one end of a fiber optic cable when finishing, testing, examining, and/or inspecting (a) the fiber optic cable itself (by, e.g., connecting it to a spectrum analyzer or power meter to analyze the signal passing through the fiber), (b) the other end of the fiber optic cable (such as, e.g., the end connector or ferrule surface at the other end), and/or (c) a component connected at the other end of the fiber optic cable; and/or (2) to test, examine, and/or inspect any quality or feature of this end of the fiber optic cable, such as, e.g., the end connector, the ferrule surface, the fiber optic cable itself, etc., as would be understood by one of ordinary skill in the art. Some non-limiting illustrative examples of test devices which may be used with a universal connector/adaptor according to the present disclosure include a power meter, a visual inspection device (such as a microscopy system) for viewing an end connector or ferrule surface of a fiber optic cable, and/or an automated cleaning system for an end connector or ferrule surface of a fiber optic cable.

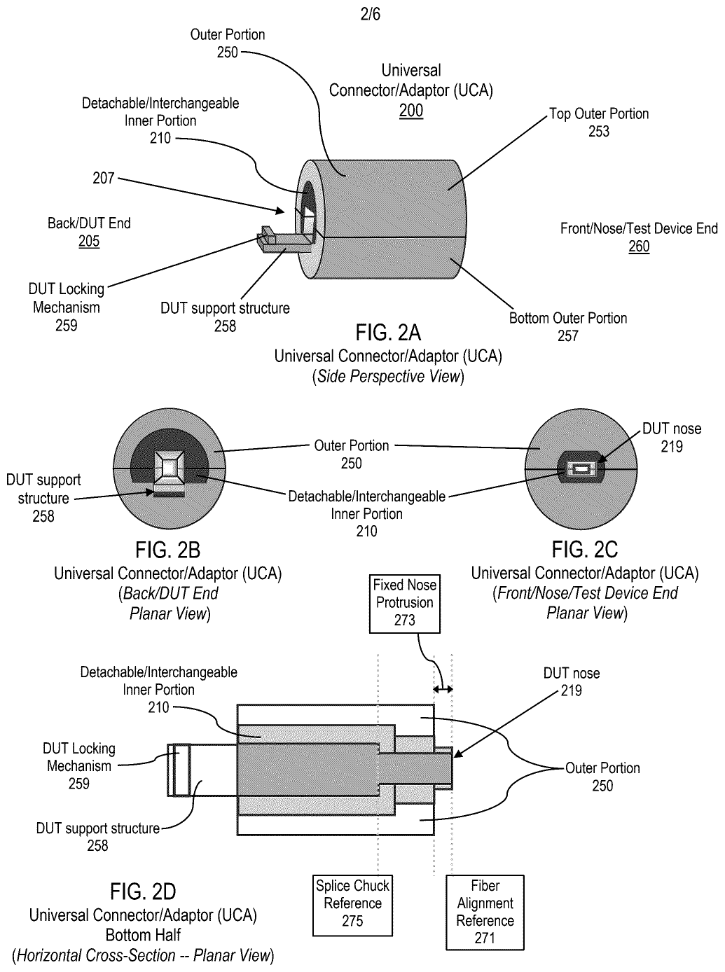

FIGS. 2A-2D illustrate a universal connector/adapter (UCA) for various Devices Under Test (DUTs) to fit into various test devices, according to an example of the present disclosure. As would be understood by one of ordinary skill in the art, the shapes, sizes, relative locations, etc., of the components in FIGS. 2A-2D may not be accurate and/or in proper proportions, but are merely shown for purposes of illustration and explanation. As would be understood by one of ordinary skill in the art, the directional terms “top” and “bottom” are used herein for the sake of convenience and ease of explanation, and are not intended to necessarily have any separate directional meaning regarding the construction of universal connector/adapters (UCAs) according to examples of the present disclosure. In some examples, the DUTs may be fiber optic cables and/or end connectors of fiber optic cables to fit into test devices.

As shown in FIGS. 2A-2D, the UCA 200 includes a detachable/interchangeable inner portion 210 which receives and holds the DUT, an outer portion 250 with a top outer portion 253 and a bottom outer portion 257. In some examples, the top outer portion 253 may be detachably connected to the bottom outer portion 257 such that the outer portion 250 may be opened so that the detachable/interchangeable inner portion 210 may be removed and replaced with a different detachable/interchangeable inner portion 210 appropriate for a different DUT. In some examples, the UCA 200 includes a back end, or DUT end, 205 (“Back/DUT end 205”) where the DUT enters the detachable/interchangeable inner portion 210 (indicated by the arrow with reference numeral 207) and a front end where a nose or other protuberance may be disposed to connect the DUT to the test device (“Front/nose/test device end 260”). In some examples, the bottom outer portion 257 may include a DUT support structure 258 on the back/DUT end 205 to hold the DUT in place and support the DUT as it is affixed within the detachable/interchangeable inner portion 210. In some examples, the DUT support structure 258 may further include a DUT locking mechanism 259 to hold the DUT securely to the DUT support structure 258. In other examples, the DUT support structure 258 and/or the DUT locking mechanism 259 may be included in the bottom of the detachable/interchangeable inner portion 210. In some examples, the DUT locking mechanism 259 may be in the form of a latching or clamping mechanism.

As shown in FIGS. 2B-2C-2D, the detachable/interchangeable inner portion 210 may be larger at the Back/DUT end 205 than at the front/nose/test device end 260 of the UCA 200, where a DUT nose 219 may extend out from the detachable/interchangeable inner portion 210 through the outer portion 250 in order to engage with the test device. In some examples, only the DUT nose 219 of the detachable/interchangeable inner portion 210 may extend from the front/nose/test device end 260, and thus the detachable/interchangeable inner portion 210 may be otherwise hidden from view (i.e., only the outer portion 250 and the DUT nose 219 may be seen).

In FIGS. 2A-2D, the outer portion 250 includes 2 portions detachably connected, the top outer portion 253 and the bottom outer portion 257. In some examples, the top outer portion 253 may be detachably connected to the bottom outer portion 257 by a frictional connection (such as, e.g., complementary threading and/or fitting, a clamping mechanism, etc.), a mechanical connection (such as, e.g., a joint or hinge permanently connecting the top outer portion 253 and the bottom outer portion 257 on one side while a snapping and/or locking mechanism is used on the other side to open and close the outer portion), and/or an electromagnetic/electronic connection (such as, e.g., a magnetic seal). In some examples, the outer portion 250 may have more or less than two component portions. For instance, the outer portion 250 may be only one solid component, where the detachable/interchangeable inner portion 210 (with the DUT) is inserted through one end of the outer portion 250 and forms a frictional connection in order to connect the inner and outer portions of the UCA 200. As another instance, the outer portion 250 may include three parts, such as a top portion, a bottom portion, and a nose portion which screws into both the top and bottom portion of the outer portion (and perhaps the detachable/interchangeable inner portion 210 as well).

The detachable/interchangeable inner portion 210 may include one or more portions, according to the particular implementation. In some examples, the inner detachable/interchangeable portion 210 may include a top portion which detachably connects to the top outer portion 253 and a bottom portion which detachably connects to the bottom outer portion 257. In some examples, the portions making up the detachable/interchangeable inner portion 210 may be detachably connected to the outer portion 250 by frictional connection (such as, e.g., complementary threading and/or fitting, a clamping mechanism, etc.) and/or a mechanical connection (such as, e.g., a snapping and/or locking mechanism). In some examples, the portions making up the detachable/interchangeable inner portion 210 may be detachably connected to the outer portion 250 by screws through complementary/matching holes in both the detachable/interchangeable inner portion 210 and the outer portion 250.

FIG. 2D is a top planar view of a cross-section of the bottom half of the UCA 200, indicating some of the key mechanical reference planes and surfaces to be employed in the construction of the detachable/interchangeable inner portion 210, according to examples of the present disclosure. As mentioned above, the shapes, sizes, relative locations, etc., of the components in FIG. 2D may not be accurate and/or in proper proportions, but are merely shown for purposes of illustration and explanation. In FIG. 2D, the detachable/interchangeable inner portion 210 may be disposed within the outer portion 250, showing both where the DUT may enter the UCA 200 when secured to the DUT support structure 258 using the DUT locking mechanism 259, and the DUT nose 219 where the DUT may be exposed to the test device for purposes of examination, inspection, and/or testing.

Also shown in FIG. 2D are three dotted lines representing different mechanical reference planes which may be employed in the construction of different detachable/interchangeable inner portions 210 for different DUTs. The Fiber Reference plane 271 may be disposed at the end of the DUT nose 219, i.e., at the point of connection between the DUT and the test device. The Fixed Nose Protrusion distance 273 may be the distance between the Fiber Reference plane 271 and the body of the UCA 200, i.e., between the end of the DUT nose 219 and the outer surface of the outer portion 250, or, equivalently, the distance the DUT nose 219 sticks out from the UCA 200. Both the Fiber Reference plane 271 and the Fixed Nose Protrusion distance 273 are known and set quantities against which other reference surfaces, planes, and/or values may be determined, calculated, and/or analyzed. In some examples, one or both of the Fiber Reference plane 271 and the Fixed Nose Protrusion distance 273 may be employed to determine the Splice Chuck Reference plane 275. In such examples, the detachable/interchangeable inner portion 210 may be intended to hold a fiber optic cable splice chuck and, accordingly, the Splice Chuck Reference plane 275 may be employed to construct the interior of the detachable/interchangeable inner portion 210 to sufficiently fit and hold the specific fiber optic splice chuck so that the test device may examine, inspect, and/or test the fiber optic cable.

Generally speaking, as shown in FIGS. 2A-2D, the UCA 200 may include the detachable/interchangeable inner portion 210 detachably connected to the outer portion 250. In some examples, the outer portion 250 may be hinged on one side, making a clamshell configuration, where the two portions making up the outer portion 250 may be opened up and exposed in order to place and replace different detachable/interchangeable inner portion(s) 210. In some examples, the detachable/interchangeable inner portion 210 may take a wide variety of shapes, forms, and sizes, depending on the DUT (and perhaps the test devices) involved, while the outer portion 250 remains the same. Accordingly, this adaptable detachable/interchangeable inner portion 210 may host splice chucks, v-grooves, ferrules, glass/poly custom pieces, any type of bare fiber optic cable, and/or any type of end connector for a fiber optic cable.

Generally speaking, considerations in constructing a UCA in accordance with the present disclosure may include, for example:
1) Nose capture: constructing the DUT nose 219 of the UCA 200 to suitably connect the DUT to the test device.
2) Inner Portion Attachment to Outer Portion: Pins, screws, and other attachments means to register and hold the detachable/interchangeable inner portion 210 in the outer portion 250 of the UCA 200.
3) DUT support structure: the optic fiber cable support on the Back/DUT end 205 of the UCA 200 (e.g., DUT support structure 258).
4) DUT locking structure: locking means to hold the fiber optic cable securely enough so that any physical strain on the fiber optic cable may not affect any measurements/tests/inspections by the test device(s) (e.g., DUT locking mechanism 259).
5) Mechanical Reference Planes/Surfaces, such as, e.g., the Fiber Reference plane 271, the Fixed Nose Protrusion distance 273, the Splice Chuck Reference plane 275, etc.
6) Suitable surface treatment for any portions of the UCA 200 which may create noise, stray light, reflections, etc., which may affect measurement of the DUT by the test device: for example, coatings and/or surface textures may be used on parts of the front/nose/test device end 260 of the UCA 200 in order to minimize reflections and other possible noise/interference/interactions which may affect power measurement, inspection equipment, etc.

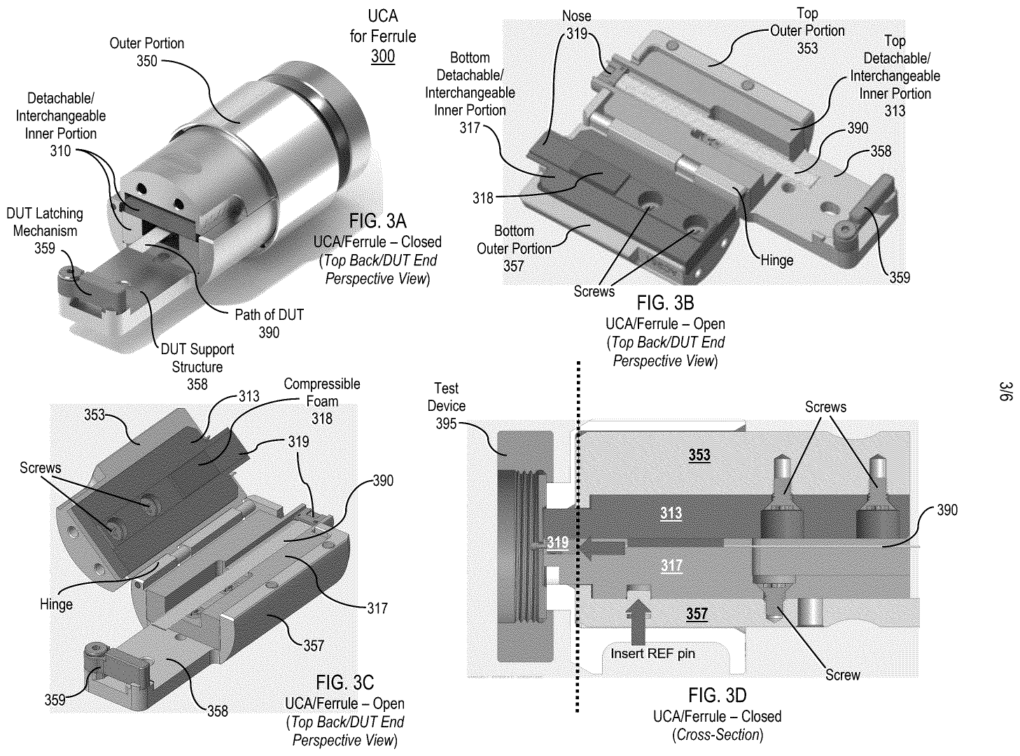

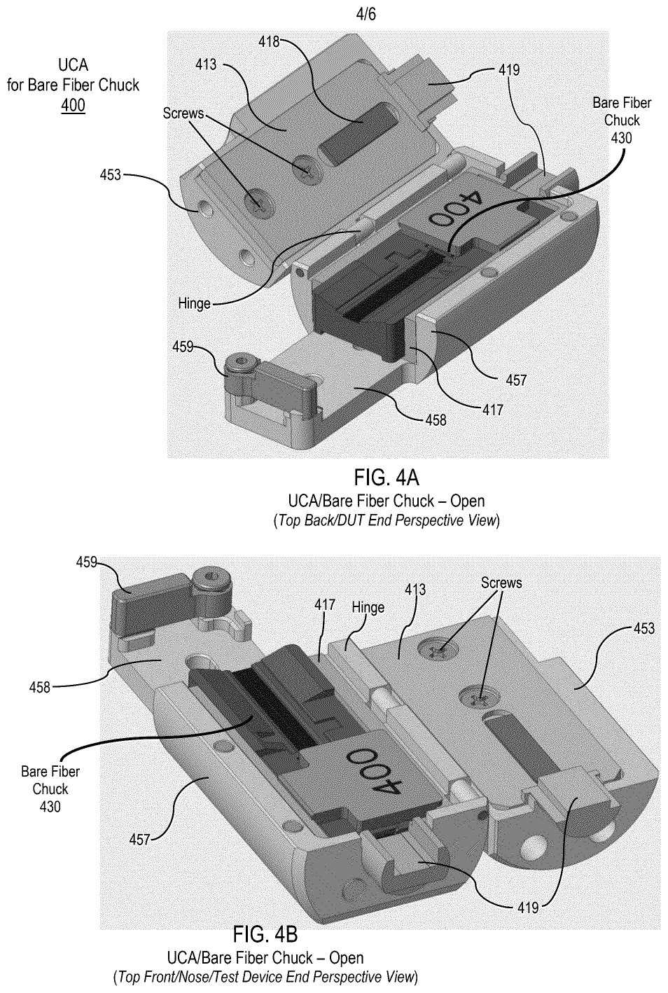

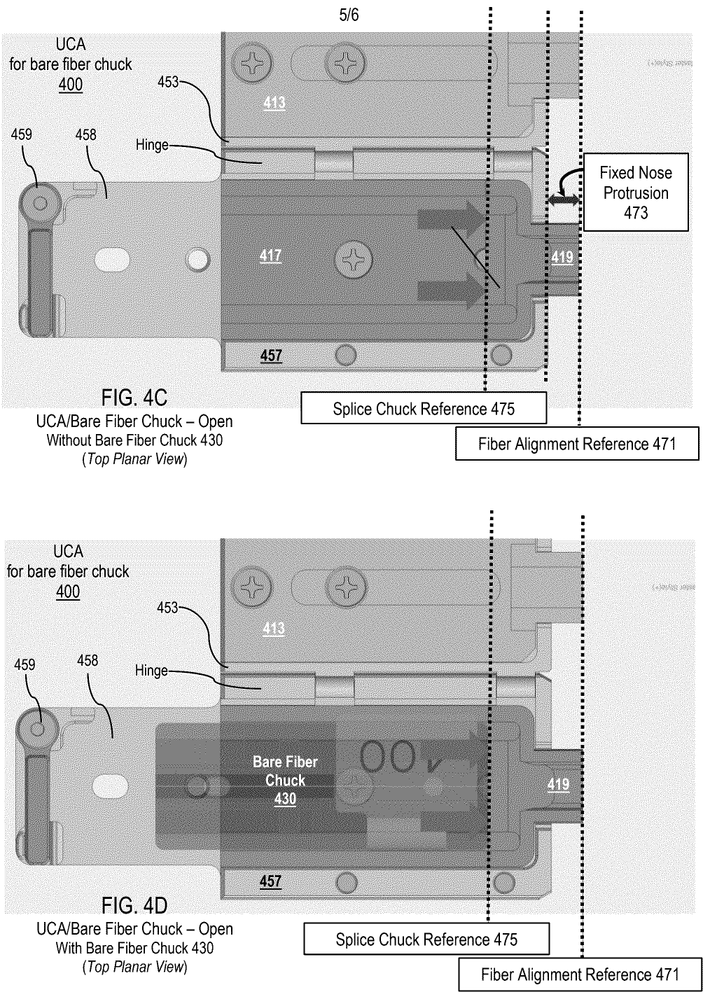

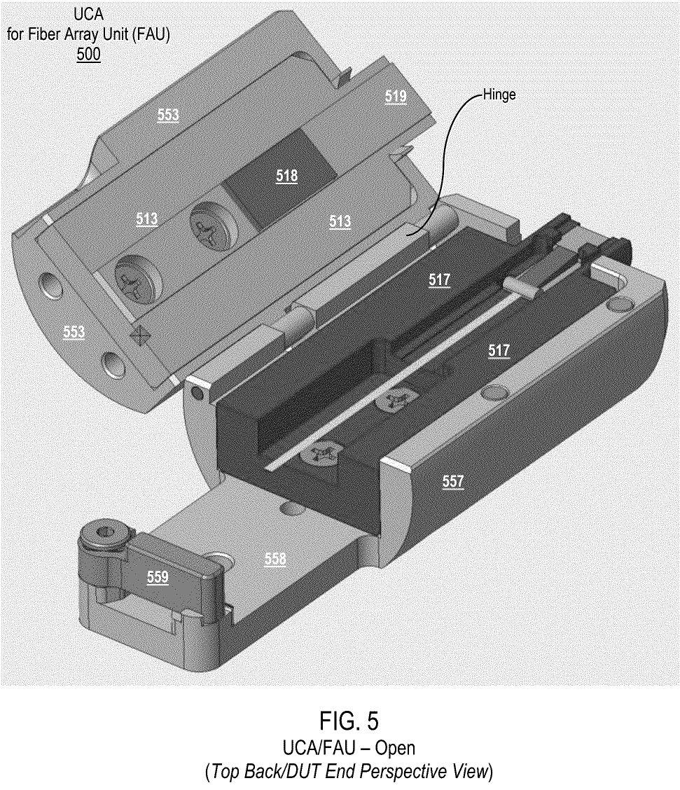

FIGS. 3A-3D, 4A-4D, and 5 below illustrate various non-limiting examples of UCAs according to the present disclosure. In FIGS. 3A-3D, the DUT intended for the detachable/interchangeable inner portion is a bare ferrule of a fiber optic cable; in FIGS. 4A-4D, the DUT intended for the detachable/interchangeable inner portion is a splice chuck which itself is holding a fiber optic cable; and in FIG. 5, the DUT intended for the detachable/interchangeable inner portion is a Fiber Array Unit (FAU).

FIGS. 3A-3D illustrate a universal connector/adapter (UCA) with an inner portion adapted for a bare ferrule of a fiber optic cable as a device under test (DUT), according to an example of the present disclosure. In FIGS. 3A-3D, a universal connector/adapter (UCA) 300 includes a detachable/interchangeable inner portion 310 adapted for the bare ferrule of a fiber optic cable (not shown), where the detachable/interchangeable inner portion 310 may be detachably connected to an outer portion 350. More specifically, the detachable/interchangeable inner portion 310 includes two portions: a bottom detachable/interchangeable inner portion 317 which may be detachably connected to a bottom outer portion 357 and a top detachable/interchangeable inner portion 313 which may be detachably connected to a top outer portion 353. In some examples, the top detachable/interchangeable inner portion 313 and/or the bottom detachable/interchangeable inner portion 317 may be screwed into their respective matching top outer portion 353 and bottom outer portion 357.

As shown in the top perspective view from the back/DUT end of the UCA 300 while closed in FIG. 3A, the outer portion 350 also includes a DUT support structure 358 to on which the ferrule may lie, as well as a DUT latching mechanism 359 to lock down the ferrule in place in the UCA 300. In some examples, a gate-like portion of the DUT latching mechanism 359 swings out in order for the DUT (i.e., the ferrule) to be placed on the DUT support structure 358 and through the detachable/interchangeable inner portion 310. In each of FIGS. 3A-3D, a flat planar line 390 indicates where the ferrule would be placed for testing/examining/inspecting.

As shown in the top perspective view from the back/DUT end of the UCA 300 while open in FIG. 3B, the outer portion 350 includes a hinge between the top outer portion 353 and the bottom outer portion 357. FIG. 3B also shows that each of the top detachable/interchangeable inner portion 313 and the bottom detachable/interchangeable inner portion 317 may be detachably connected to a top outer portion 353 and a bottom outer portion 357, respectively, by one or more screws. In FIG. 3B, the flat planar line 390 indicates the path on and in which the ferrule may be secured when the UCA 300 is closed. Compressible foam 318 may assist in holding the DUT in place when the top detachable/interchangeable inner portion 313 and the bottom detachable/interchangeable inner portion 317 are closed together. FIG. 3B also shows a nose 319 of the detachable/interchangeable inner portion 310 where the ferrule may interface with a test device.

FIG. 3C is the same top perspective view from the back/DUT end of the UCA 300 in FIG. 3A, but the UCA 300 is open in FIG. 3C thereby showing the top detachable/interchangeable inner portion 313 and the bottom detachable/interchangeable inner portion 317 included in the detachable/interchangeable inner portion 310 and the top outer portion 353 and the bottom outer portion 357 included in the outer portion 350, as well as the hinge connecting them.

FIG. 3D is a cross-section of the UCA 300 while closed and inserted into a test device 395. As shown in FIG. 3D, both the top and bottom portions of the outer portion 350 and the detachable/interchangeable inner portion 310 may be closed together and secured, thereby forming a complete nose 319 of the UCA 300 which may be securely fastened to the test device 395 for testing/examining/inspecting.

FIGS. 4A-4D illustrate a universal connector/adapter (UCA) with an inner portion adapted for a chuck of a bare fiber optic cable as a device under test (DUT), according to an example of the present disclosure. In some examples, the chuck is from a fiber optic fusion splicer, i.e., a bare fiber chuck 430. In FIGS. 4A-4D, a universal connector/adapter (UCA) 400 includes a two-piece detachable/interchangeable inner portion adapted for the bare fiber chuck 430 (within which a bare fiber optic cable may be disposed), where the two-piece detachable/interchangeable inner portion may be detachably connected to an outer portion.

In the example shown in FIG. 4A, the bare fiber chuck 430 may be a splice chuck for a Fujikura fusion splicer. In other examples, the bare fiber chuck 430 may be a chuck for holding a bare fiber optic cable in another sort of test device. As shown in FIGS. 4A-4B, a bottom detachable/interchangeable inner portion 417 may be specifically shaped and portioned to hold a splice chuck for a Fujikura fusion splicer; however, the bottom detachable/interchangeable inner portion 417 may be specifically shaped and portioned to hold any type of bare fiber chuck 430.

As shown in the top perspective view from the back/DUT end of the UCA 400 while open in FIG. 4A and the top perspective view from the front/nose/test device end of the UCA 400 while open in FIG. 4B, the two-piece detachable/interchangeable inner portion includes the bottom detachable/interchangeable inner portion 417 which may be detachably connected to a bottom outer portion 457 and a top detachable/interchangeable inner portion 413 which may be detachably connected to a top outer portion 453. In some examples, the top detachable/interchangeable inner portion 413 and/or bottom detachable/interchangeable inner portion 417 may be screwed into their respective matching top outer portion 453 and/or bottom outer portion 457. Compressible foam 418 may assist in holding the DUT in place when the top detachable/interchangeable inner portion 413 and the bottom detachable/interchangeable inner portion 417 are closed together. Similarly to the UCA 300 in FIGS. 3A-3D, the outer portion of the UCA 400 includes a DUT support structure 458 to on which the bare fiber chuck may lie, as well as a DUT latching mechanism 459 to lock down the bare fiber chuck in place in the UCA 400. In some examples, a gate-like portion of the DUT latching mechanism 459 swings out in order for the DUT (i.e., the bare optic fiber cable feeding into the bare fiber chuck 430) to be placed on the DUT support structure 458 and through the two-piece detachable/interchangeable inner portion. FIGS. 4A-4B also show that the outer portion includes a hinge between the top outer portion 453 and the bottom outer portion 457, and a nose 419 of the two-piece detachable/interchangeable inner portion where the end(s) of the bare fiber optic cable may interface with a test device.

FIGS. 4C-4D illustrate various reference features and/or values useful in constructing a universal connector/adapter in accordance with examples of the present disclosure. More specifically, FIG. 4C illustrates how the Fiber Alignment Reference plane 471 and the Fixed Nose Protrusion distance 473 may relate to the Splice Chuck reference plane 475. The bare fiber chuck 430 is not in FIG. 4C; whereas the bare fiber chuck 430 is inserted into the bottom detachable/interchangeable inner portion 417 in FIG. 4D. Accordingly, FIG. 4D illustrates how the end of the bare fiber chuck 430 (the end is indicated by the two arrows) may be set at the Splice Chuck reference plane 475 when the bare fiber chuck 430 is in place. In a similar manner, different detachable/interchangeable inner portions may be constructed to fit different chucks for different test devices—i.e., by establishing the appropriate Splice Chuck reference plane 475 for the specific chuck in relation to the set values for the Fiber Alignment Reference plane 471 and the Fixed Nose Protrusion distance 473.

FIG. 5 illustrates a universal connector/adapter (UCA) with an inner portion adapted for a fiber array unit (FAU) as a device under test (DUT), according to an example of the present disclosure. In FIG. 5, a universal connector/adapter (UCA) 500 includes a two-piece detachable/interchangeable inner portion adapted for a FAU (not shown), where the two-piece detachable/interchangeable inner portion may be detachably connected to an outer portion. More specifically, the two-piece detachable/interchangeable inner portion includes a bottom detachable/interchangeable inner portion 517 which may be detachably connected to a bottom outer portion 557 and a top detachable/interchangeable inner portion 513 which may be detachably connected to a top outer portion 553. Compressible foam 518 may assist in holding the DUT in place when the top detachable/interchangeable inner portion 513 and the bottom detachable/interchangeable inner portion 517 are closed together. In some examples, the top detachable/interchangeable inner portion 513 and/or the bottom detachable/interchangeable inner portion 517 may be screwed into their respective matching top outer portion 553 and/or bottom outer portion 557.

As shown in the top perspective view from the back/DUT end of the UCA 500 while open in FIG. 5, the outer portion also includes a DUT support structure 558 to on which the ferrule may lie, as well as a DUT latching mechanism 559 to lock down the ferrule in place in the UCA 500. In some examples, a gate-like portion of the DUT latching mechanism 559 swings out in order for the DUT (i.e., the FAU) to be placed on the DUT support structure 558 and through the two-piece detachable/interchangeable inner portion. The outer portion may include a hinge between the top outer portion 553 and the bottom outer portion 557 and each of the top detachable/interchangeable inner portion 513 and the bottom detachable/interchangeable inner portion 517 may be detachably connected to the top outer portion 553 and the bottom outer portion 557, respectively, by one or more screws. FIG. 5 also shows a nose 519 of the two-piece detachable/interchangeable inner portion where the FAU may interface with a test device.

As described above, systems, devices, and methods for a universal connector/adaptor according to examples of the present disclosure may enable the cleaning, polishing, inspecting, examining, and/or any type of testing or finishing of any type of fiber optic cable (including any part of the fiber optic cable, such as, e.g., any bare ferrule surface of the fiber optic cable, any type of end connector of the fiber optic cable, any bare end of the fiber optic cable, etc., as would be understood by one of ordinary skill in the art). Moreover, systems, devices, and methods for a universal connector/adaptor according to examples of the present disclosure may enable the cleaning, polishing, inspecting, examining, and/or any type of testing or finishing of any type of the rapidly proliferating varieties of fiber optic cables, and in a wide variety of environments (including, e.g., in a factory where fiber optic cables are manufactured; in a laboratory where a network or system using fiber optic cables is being field tested; in the field where a technician may be testing/inspecting/examining components and/or systems which are or will be actively using fiber optic cable, etc.). For example, a technician may use a universal connector/adaptor according to examples of the present disclosure to test/inspect/examine one or more fiber optic cables when testing/inspecting/examining an optic fiber-based network, such as a Wide Area Network (WAN), and/or any components or nodes in a fiber optic-based network, such as an Internet device (e.g., an Internet of Things (IoT) device). As another example, a technician may use a universal connector/adaptor according to examples of the present disclosure to test/inspect/examine one or more fiber optic cables when testing/inspecting/examining any component, node, or part of a telecommunications network, such as a cell site, a base station, a fronthaul, backhaul or other type of link between nodes or network system components, etc., as would be understood by one of ordinary skill in the art.

As described above and indicated by the variety of examples in FIGS. 2A-2D, 3A-3D, 4A-4D, and 5, examples according to the present disclosure may be implemented in a wide array of possible constructions, as long as the outer portion (and, in some cases, portions of the inner portion) of the universal connector/adaptor is suitably constructed to fit a variety of test devices, and each of the detachable/interchangeable inner portions is suitable constructed to fit one or more specific DUTs. To that end, one or more reference planes, surfaces, and/or other values/dimensions may be employed to ensure appropriate interchangeability.

In one aspect, a universal connector/adaptor (UCA) for adapting devices under test (DUTs) to one or more test devices is described herein, including: an outer portion including a hollow inside and a support structure extending from a first side of the outer portion, wherein a second side of the outer portion opposite the first side is to connect with any of the one or more test devices; and a detachable inner portion detachably connected to the hollow inside of the outer portion. The detachable inner portion includes a nose which extends through the second side of the outer portion. The detachable inner portion may be shaped to receive and hold a specific DUT from the support structure on the first side of the outer portion and to connect the specific DUT to any of the one or more test devices via the nose on the second side of the outer portion.

In some examples, the outer portion of the UCA includes: a top outer portion; and a bottom outer portion connected to the top outer portion, wherein the support structure extends from the bottom outer portion on the first side of the outer portion. In some examples, the outer portion of the UCA further includes: a hinge connecting the top outer portion to the bottom outer portion, wherein the hinge allows the top outer portion and the bottom outer portion to open and close such that the detachable inner portion may be attached and detached from the hollow inside of the outer portion. In some examples, the outer portion of the UCA further includes: a frictional connection between the top outer portion and the bottom outer portion, wherein the frictional connection allows the top outer portion and the bottom outer portion to open and close such that the detachable inner portion may be attached and detached from the hollow inside of the outer portion.

In some examples, the detachable inner portion of the UCA includes: a top inner portion to detachably connect to the top outer portion; and a bottom inner portion to detachably connect to the bottom outer portion. In some examples, the bottom inner portion is further shaped to receive and hold the specific DUT from the support structure on the first side of the outer portion and to connect the specific DUT to any of the one or more test devices via the nose on the second side of the outer portion.

In another aspect, a universal connector/adaptor (UCA) system for adapting devices under test (DUTs) to a plurality of test devices is described herein, including: an outer portion including a hollow inside and a support structure extending from a first side of the outer portion, wherein a second side of the outer portion opposite the first side is to connect with any of the plurality of test devices; and a plurality of detachable/interchangeable inner portions. Each of the plurality of detachable/interchangeable inner portions may detachably connect to the hollow inside of the outer portion. Each of the plurality of detachable/interchangeable inner portions may include a nose which extends through the second side of the outer portion, and may be shaped to receive and hold a specific DUT from the support structure on the first side of the outer portion and to connect the specific DUT to any of the plurality of test devices via the nose on the second side of the outer portion.

In some examples, the outer portion of the UCA system may include: a top outer portion; and a bottom outer portion connected to the top outer portion, wherein the support structure extends from the bottom outer portion on the first side of the outer portion. In some examples, the outer portion of the UCA system may include: a hinge connecting the top outer portion to the bottom outer portion, wherein the hinge allows the top outer portion and the bottom outer portion to open and close such that each of the plurality of detachable/interchangeable inner portions may be attached and detached from the hollow inside of the outer portion. In some examples, the outer portion of the UCA system may include: a frictional connection between the top outer portion and the bottom outer portion, wherein the frictional connection allows the top outer portion and the bottom outer portion to open and close such that each of the plurality of detachable/interchangeable inner portions may be attached and detached from the hollow inside of the outer portion.

In some examples, each of the plurality of detachable/interchangeable inner portions of the UCA system may include: a top inner portion to detachably connect to the top outer portion; and a bottom inner portion to detachably connect to the bottom outer portion. In some examples, the bottom inner portion of each of the plurality of detachable inner portions is further shaped to receive and hold the specific DUT from the support structure on the first side of the outer portion and to connect the specific DUT to any of the plurality of test devices via the nose on the second side of the outer portion.

In yet another aspect, a universal connector/adaptor (UCA) system for adapting a plurality of fiber optic cables to connect to a plurality of test devices is described herein, which may include: an outer portion including a top outer portion, a bottom outer portion, and a support structure, wherein the top and bottom outer portions are connected by a hinge and close together to form a hollow inside, wherein the support structure extends from the bottom outer portion on a first side of the outer portion, and wherein a second side of the outer portion opposite the first side is to connect with any of the plurality of test devices; and a plurality of detachable/interchangeable inner portions. In some examples, each of the plurality of detachable/interchangeable inner portions may detachably connect to the hollow inside of the outer portion; may include a nose which extends through the second side of the outer portion; and may be shaped to receive and hold a specific fiber optic cable from the support structure on the first side of the outer portion and to connect the specific fiber optic cable to any of the plurality of test devices via the nose on the second side of the outer portion.

While examples described herein are directed to configurations as shown, it should be appreciated that any of the components described or mentioned herein may be altered, changed, replaced, or modified, in size, shape, and numbers, or material, depending on application or use case, and adjusted for desired resolution or optimal measurement results. Moreover, single components may be provided as multiple components, and vice versa, to perform the functions and features described herein. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and interfaces may be any number of mechanical, electrical, hardware, network, or software components, circuits, elements, and interfaces that serves to facilitate communication, exchange, and analysis data between any number of or combination of equipment, protocol layers, or applications. For example, the components described herein may each include a network or communication interface to communicate with other servers, devices, components or network elements via a network or other communication protocol.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A universal connector/adaptor (UCA) for adapting devices under test (DUTs) to one or more test devices, comprising:
an outer portion comprising a hollow inside and a support structure extending from a first side of the outer portion, wherein a second side of the outer portion opposite the first side is to connect with any of the one or more test devices; and
a detachable inner portion detachably connected to the hollow inside of the outer portion, the detachable inner portion comprising a nose which extends through the second side of the outer portion, the detachable inner portion being shaped to receive and hold a specific DUT from the support structure on the first side of the outer portion and to connect the specific DUT to any of the one or more test devices via the nose on the second side of the outer portion.

2. The UCA of claim 1, wherein the outer portion comprises:
a top outer portion; and
a bottom outer portion connected to the top outer portion, wherein the support structure extends from the bottom outer portion on the first side of the outer portion.

3. The UCA of claim 2, wherein the outer portion comprises:
a hinge connecting the top outer portion to the bottom outer portion, wherein the hinge allows the top outer portion and the bottom outer portion to open and close such that the detachable inner portion may be attached and detached from the hollow inside of the outer portion.

4. The UCA of claim 2, wherein the outer portion comprises:
a frictional connection between the top outer portion and the bottom outer portion, wherein the frictional connection allows the top outer portion and the bottom outer portion to open and close such that the detachable inner portion may be attached and detached from the hollow inside of the outer portion.

5. The UCA of claim 2, wherein the detachable inner portion comprises:
a top inner portion to detachably connect to the top outer portion; and
a bottom inner portion to detachably connect to the bottom outer portion.

6. The UCA of claim 5, wherein the bottom inner portion is further shaped to receive and hold the specific DUT from the support structure on the first side of the outer portion and to connect the specific DUT to any of the one or more test devices via the nose on the second side of the outer portion.

7. The UCA of claim 1, wherein the specific DUT comprises at least one of a fiber optic cable, an end connector of a fiber optic cable, an end of a fiber optic cable, or a chuck to hold a fiber optic cable.

8. The UCA of claim 1, wherein the specific DUT comprises at least one of a ferrule, a bare fiber chuck, or a fiber array unit (FAU).

9. The UCA of claim 1, wherein each of the one or more test devices comprise a device to perform at least one of cleaning, polishing, finishing, inspecting, examining, or testing a DUT.

10. The UCA of claim 1, wherein each of the one or more test devices comprise a device to perform at least one of cleaning, polishing, finishing, inspecting, examining, or testing at least one of an end connector of a fiber optic cable, an end of a fiber optic cable, or a fiber optic cable.

11. A universal connector/adaptor (UCA) system for adapting devices under test (DUTs) to a plurality of test devices, comprising:
an outer portion comprising a hollow inside and a support structure extending from a first side of the outer portion, wherein a second side of the outer portion opposite the first side is to connect with any of the plurality of test devices; and
a plurality of detachable/interchangeable inner portions, wherein:
each of the plurality of detachable/interchangeable inner portions is to detachably connect to the hollow inside of the outer portion,
each of the plurality of detachable/interchangeable inner portions comprises a nose which extends through the second side of the outer portion, and
each of the plurality of detachable/interchangeable inner portions is shaped to receive and hold a specific DUT from the support structure on the first side of the outer portion and to connect the specific DUT to any of the plurality of test devices via the nose on the second side of the outer portion.

12. The UCA system of claim 11, wherein the outer portion comprises:
a top outer portion; and
a bottom outer portion connected to the top outer portion, wherein the support structure extends from the bottom outer portion on the first side of the outer portion.

13. The UCA system of claim 12, wherein the outer portion comprises:
a hinge connecting the top outer portion to the bottom outer portion, wherein the hinge allows the top outer portion and the bottom outer portion to open and close such that each of the plurality of detachable/interchangeable inner portions may be attached and detached from the hollow inside of the outer portion.

14. The UCA system of claim 12, wherein the outer portion comprises:
a frictional connection between the top outer portion and the bottom outer portion, wherein the frictional connection allows the top outer portion and the bottom outer portion to open and close such that each of the plurality of detachable/interchangeable inner portions may be attached and detached from the hollow inside of the outer portion.

15. The UCA system of claim 12, wherein each of the plurality of detachable/interchangeable inner portions comprises:
a top inner portion to detachably connect to the top outer portion; and
a bottom inner portion to detachably connect to the bottom outer portion.

16. The UCA system of claim 15, wherein the bottom inner portion of each of the plurality of detachable inner portions is further shaped to receive and hold the specific DUT from the support structure on the first side of the outer portion and to connect the specific DUT to any of the plurality of test devices via the nose on the second side of the outer portion.

17. The UCA system of claim 11, wherein the specific DUT comprises at least one of a fiber optic cable, an end connector of a fiber optic cable, an end of a fiber optic cable, or a chuck to hold a fiber optic cable.

18. The UCA system of claim 11, wherein the specific DUT comprises at least one of a ferrule, a bare fiber chuck, or a fiber array unit (FAU).

19. The UCA system of claim 17, wherein each of the plurality of test devices comprise a device to perform at least one of cleaning, polishing, finishing, inspecting, examining, or testing a DUT.

20. A universal connector/adaptor (UCA) system for adapting a plurality of fiber optic cables to connect to a plurality of test devices, comprising:
an outer portion comprising a top outer portion, a bottom outer portion, and a support structure, wherein the top and bottom outer portions are connected by a hinge and close together to form a hollow inside, wherein the support structure extends from the bottom outer portion on a first side of the outer portion, and wherein a second side of the outer portion opposite the first side is to connect with any of the plurality of test devices; and
a plurality of detachable/interchangeable inner portions, wherein:
each of the plurality of detachable/interchangeable inner portions is to detachably connect to the hollow inside of the outer portion,
each of the plurality of detachable/interchangeable inner portions comprises a nose which extends through the second side of the outer portion, and
each of the plurality of detachable/interchangeable inner portions is shaped to receive and hold a specific fiber optic cable from the support structure on the first side of the outer portion and to connect the specific fiber optic cable to any of the plurality of test devices via the nose on the second side of the outer portion.
